(19) United States
(12) Patent Application Publication
(10) Pub. No.: US 2004/0103992 A1
(43) Pub. Date: Jun. 3, 2004

(54) Paste unit for a bottom guide device

(76) Inventors: Ruediger Duwendag, Lengerich (DE); Guido Kerres, Muenster (DE); Andrees Erdmann, Osnabrueck (DE)

Correspondence Address: JACOBSON HOLMAN PLLC, 400 SEVENTH STREET N.W., SUITE 600, WASHINGTON, DC, 20004, US

(21) Appl. No.: 10/721,068

(22) Filed: Nov. 26, 2003

(30) Foreign Application Priority Data
Nov. 27, 2002 (DE) 102 55 485.4

(51) Int. Cl. B65C 11/04

(52) U.S. Cl. 156/578

(57) ABSTRACT

A paste unit (3) for a bottom guide device for star seal bottom bags, which are formed of tube sections, is introduced. The paste unit (3) serves for the glueing of bottom warps, or star seal bottom bags. The unit's characteristics are a glue reservoir (1), or a glue source (5), a metering roller (2), a glue application roller (3), as well as a making roller (4). Drive means are assigned to the rollers.

Innovating and inventive is the fact that the glue (9) is transferred to the printing roller (4) by the glue application roller (3). This closed system provides the advantage that the glue (9) is applied evenly, and that the metering can be adjusted at a very fine setting. Furthermore, no glue (9) can be discharged to the environment of the paste unit.

The invention relates to a paste unit for a bottom guide device for star seal bottom bags according to the generic term of claim 1.

In a paste unit of a bottom guide device, glue is applied to the reared end, or the reared ends, and the thereby formed corner wraps of a tube section made of paper, plastic, or another suitable material, in order to subsequently achieve a permanently glued bag bottom by means of placing the reared ends onto the corner wraps.

A typically utilized paste unit of a bottom guide device is, for example, illustrated in patent specification DE 196 34 594 C2. A metering roller and a glue application roller are supported in a base plate, which together form a closed system in a body, in which a glue column of desired height is held. The glue is transferred to the printing roller to the glue application roller, whereas the amount of glue to be transferred is adjusted by the suitable selection of the distance of the metering roller and the glue application roller. The printing roller transfers the glue to the workpiece to be glued. The closed system offers the advantage that the glue is applied evenly, and that the metering can be adjusted in very sensitive settings. Furthermore, no glue can be spread to the environment of the paste unit, which would cause contamination, as well as unnecessary glue consumption.

An open system is used in other known paste units. Principally, they are the same paste units as previously described, but instead of a body serving as the glue reservoir, a nozzle is merely used as the glue source. This nozzle is attached on the side of the gap between the metering roller and the glue application roller opposite of the printing roller. In such a paste unit, the rollers must be arranged vertically, whereas the nozzle applies the glue at the upper end of the metering roller on its exterior circumference. By means of gravitation and the rotation of the metering roller, the glue is distributed across the entire surface. The glue is fed from the metering roller across the glue application roller, and the printing roller is fed to the workpiece. The open system is said to have benefits with the use of certain types of glue. Due to the short duration of the glue in an open system—the use of this system leads to high losses of glue—the same can supply only a small amount of a solvent, and is therefore not prone to drying on.

The task of the invention is therefore to provide a device, which combines the benefits of both pasting devices, and can be provided at a low cost.

According to the invention, this task is solved by means of the characteristics of the characteristic part of claim 1.

Accordingly, the metering roller can at least sequentially be connected to a glue source, as well as to a glue reservoir. In such a paste unit, nearly all glue types can be processed, which are used for the production of star seal bottom bags. Suitable glue types can be retained in the glue reservoir, whereas such glue types, which do not allow processing from a glue reservoir, are applied to the metering roller by means of a nozzle.

It is especially advantageous, if the direction of rotation of the metering roller can be reversed. In a closed system, the metering roller usually has the same direction of rotation as the glue application roller in order to prevent an unintentional discharge of glue from the reservoir. In an open system, however, the metering roller should have an opposite direction of rotation in relation to the glue application roller for the purpose of an optimal glue transfer.

At least one of the previously mentioned rollers advantageously has its own drive motor for the simple reversal of the direction of rotation.

It is also advantageous that at least one of the previously mentioned rollers has its own electric motor, which is supplied with current by means of a power electronic power source.

In an especially advantageous embodiment of the invention, this roller is the metering roller.

Additional embodiment examples of the invention are found in the objective description and the claims.

The individual figures show:

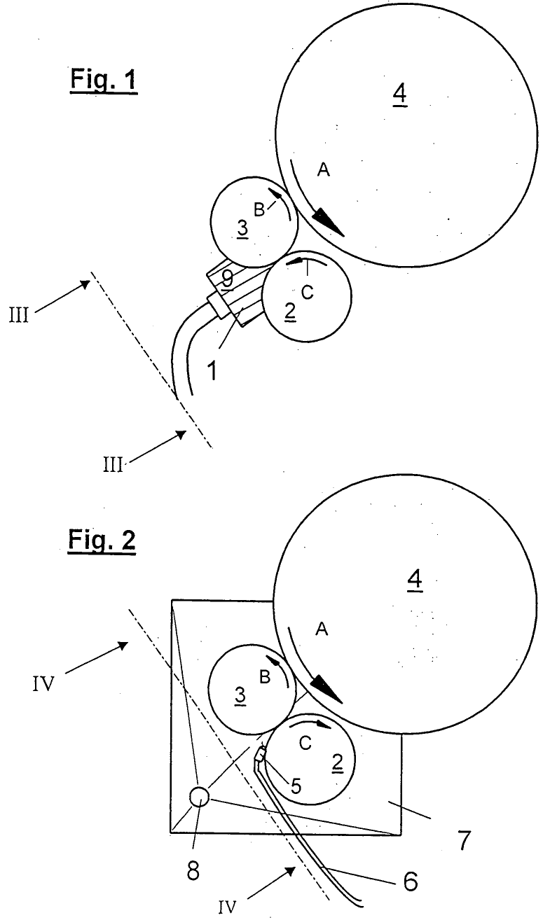

FIG. 1 Top view of a closed paste unit

FIG. 2 Top view of an open paste unit

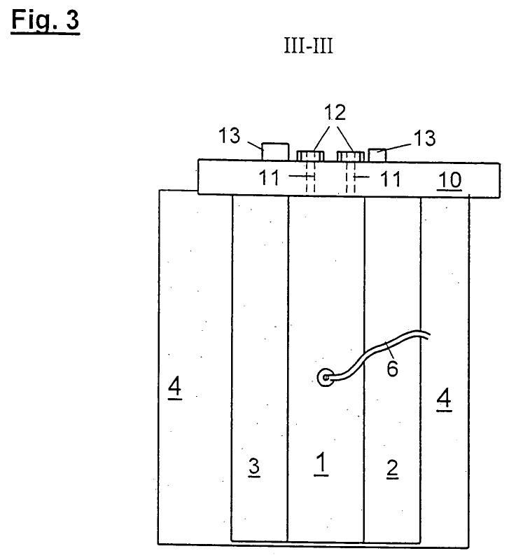

FIG. 3 Side view according to section III-III in FIG. 1

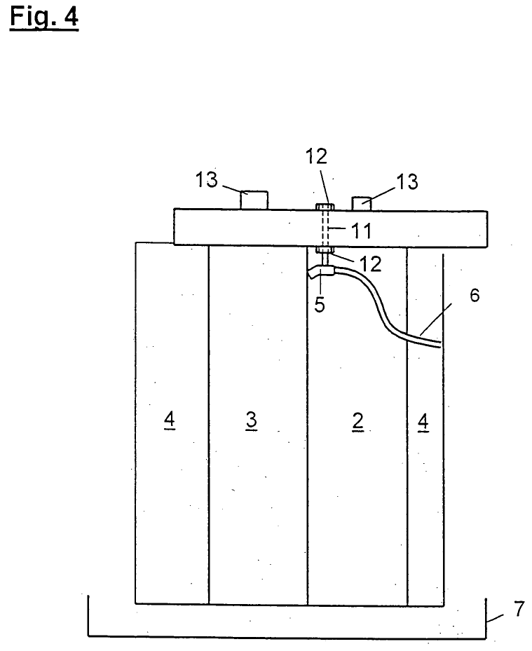

FIG. 4 Side view according to section IV-IV in FIG. 2

FIG. 1 shows a paste unit of a bottom guide device with a closed glue application system.

The glue 9 is located in the glue reservoir 1. The glue reservoir, as well as the rollers 2, 3, and 4, are attached to a base plate, which is not illustrated. The side walls of the glue reservoir 9 are in contact with the metering roller 2 and the glue application roller 3 so that no glue may escape at these contact ends. The glue 9 is carried by the glue application roller 3, and can pass the adjustable gap between the metering roller 2 and the glue application roller 3. The directions of rotation B and C of the metering roller 2 and the glue application roller 3 are the same. The direction of rotation C shown prevents the metering roller 2 from also transporting glue 9 from the glue reservoir 1. Additional details regarding the storage of rollers 2, 3, and the attachment of the glue reservoir 1 are described in patent specification DE 196 34 594 C2.

FIG. 2 shows the same paste unit in an operating mode as an open glue application system. In order to prepare the paste unit for this operating method, the glue reservoir 1 is disassembled, and a glue nozzle 5 is attached on the base plate, which is not illustrated. In order to operate the open paste unit, the glue application roller 3 and the printing roller 4 maintain their direction of rotation. The direction of rotation of the metering roller is reversed with regard to the closed operating mode. The glue is fed to the glue nozzle 5 via a feed line 6, which is arranged at the upper end of the metering roller 2. The glue nozzle 5 applies the glue onto the metering roller. The glue is transferred to the glue application roller 3, and subsequently reaches the printing roller, which transfers the glue to the workpiece to be glued. A glue pan 7 is arranged below the metering roller 2 and the printing roller 3, which catches the glue dripping from and catapulted by the rollers, and discharges it via a drain 8.

FIG. 3 shows a closed paste unit according to section III-III in FIG. 1. The rollers 2, 3 form one end with their roller axes 13, and are pivoted in the base plate 10. The base plate is not connected to the machine rack in a more detailed manner. The roller axes 13 can be driven by means of attached drives, such as toothed belt disks, on which a toothed belt is carried. Two bolts 11 are firmly attached to the glue reservoir, which can be inserted through two through bores in the base plate 10. Above the base plate, the bolts, which have a thread at least at their upper ends, are secured with nuts 12, such as knurled nuts. In this way, the glue reservoir 1 can easily be attached to the base plate 10, or removed from the same.

FIG. 4 shows an open paste unit according to section IV-IV in FIG. 2. After removing the glue reservoir 1, a bolt 11 can be inserted through one of the through bores in the base plate 10, on which the glue nozzle 5 is attached. The bolt 11 is secured from falling out by means of a nut 12, which is screwed onto the bolt 11 above the base plate. An additional nut 12 can be screwed onto the bolt 11 below the base plate 10 for the purpose of height adjustment.

Reference Symbol List

| | |
|---|---|
| 1 | Glue reservoir |
| 2 | Metering roller |
| 3 | Glue application roller |
| 4 | Printing roller |
| 5 | Glue nozzle/source |
| 6 | Feed line |
| 7 | Glue pan |
| 8 | Drain |
| 9 | Glue |
| 10 | Base plate |
| 11 | Bolt |
| 12 | Nut |
| 13 | Roller axis |
| A | Direction of rotation of the printing roller 4 |
| B | Direction of rotation of the glue application roller 3 |
| C | Direction of rotation of the glue application roller 2 |

1. Paste unit for a bottom guide device for star seal bottom bags, which are formed from tube sections, for glueing of bottom warps or star seal bottom bags, and which has at least the following characteristics:
a glue reservoir (1), or a glue source (5)
a metering roller (2), which is in contact with the glue source, or the glue reservoir (1)
a glue application roller (3), which may be in contact with the glue reservoir, or the glue source,
a making roller, which is in contact with the glue application roller (3), and which transfers glue (9) from this roller to the bottom warps, or star seal bottoms
whereby drive means are assigned to the above mentioned rollers
characterized that
the metering roller (2), and/or the glue application roller (3) can at least sequentially be connected to a glue source (5), as well as to a glue reservoir (1).

2. Paste unit according to claim 1
characterized that
the direction of rotation (C) of the metering roller (2) can be reversed.

3. Paste unit according to claim 2
characterized that
at least one of the previously mentioned rollers (1, 2, 3) has its own drive motor.

4. Paste unit according to claim 3
characterized that
at least one of the previously mentioned rollers (1, 2, 3) has its own drive motor, which is supplied with current by means of a power electronic power source—such as a frequency converter.

5. Paste unit according to claim 4
characterized that
this roller is the metering roller (2).
